(19) United States
(12) Patent Application Publication
(10) Pub. No.: US 2008/0085392 A1
(43) Pub. Date: Apr. 10, 2008

(54) Rolled film employable for laminating machine

(76) Inventor: Tadashi Kiyono, Saitama (JP)

Correspondence Address: CLARK & BRODY, 1090 VERMONT AVENUE, NW, SUITE 250, WASHINGTON, DC, 20005, US

(21) Appl. No.: 11/727,376

(22) Filed: Mar. 26, 2007

(30) Foreign Application Priority Data
Oct. 6, 2006 (JP) 2006-275838

(51) Int. Cl. B32B 1/08

(52) U.S. Cl. 428/98

(57) ABSTRACT

This invention is aimed at providing a rolled film employable for supplying a film that is applied a bonding agent on one surface thereof, toward a laminating machine, the rolled film being free from possibility to be arranged in a wrong direction wherein the bonding agent causes a problem. The rolled film is equipped with an axis having both ends respectively having coupling means for coupling the axis with the laminating machine, the coupling means on one axis end does not match the other end of the axis, thereby arrangement of the rolled film in a wrong direction is not allowed.

### FIELD OF THE INVENTION

This invention relates to an improvement applicable to a rolled film that is an apparatus employable for supplying a film that is applied a bonding agent on one surface of the film, toward a laminating machine that has a function to laminate a film or films on one or both surfaces of a tangible object e.g. a book, a picture, a document or a type of compact apparatus such as paper money, pendant et al., or the like, for the purpose to protect the tangible object from the external atmosphere and/or the external physical force or for the purpose to make it easy to observe or scrutinize such a tangible object. More specifically, this invention relates to an improvement applicable to the structure of means for coupling the rolled film and the laminating machine, the improvement being developed for the ultimate purpose to remove drawbacks that are caused by an action for arranging the rolled film to the laminating machine in an erroneous direction.

### BACKGROUND ART

Some of the specific tangible objects, e.g. a book, a picture, a document, a type of compact apparatus or the like, are preferably laminated by a film that is applied a bonding agent on a surface of the film, for the purpose to protect the tangible objects from the external atmosphere and/or for the purpose to protect the tangible objects from the external physical force, or are preferably laminated by a transparent film that is applied a bonding agent on a surface of the film, for the purpose to make the tangible objects easy to observe or scrutinize. The foregoing tangible objects are called “objects to be laminated”, in this specification. Incidentally, the machine that is employed for the purpose of the foregoing lamination is called a laminating machine. The rolled film of this invention is a supply that is employed for a specific model of the laminating machines.

### DRAWBACKS REMOVED BY THIS INVENTION

Referring to FIGS. 1 and 2, two examples of the foregoing laminating machines available in the prior art will be described below. A rectangle 4 that is an object of which one or both surfaces are scheduled to be laminated by the foregoing film or films, is fed along the top surface of a table 1. In either example, a rolled film 31 supplies a film 3 that is applied a bonding agent on one surface of the film, towards a heating and pressing roll 21 and/or 22. The film 3 that is applied a bonding agent on one surface of the film 3, is scheduled to be laminated on the surface of the rectangle 4. In the process to lamination, it is important to cause the surface A of the film 3 that is the surface applied a bonding agent, to contact the object 4 that is scheduled to be laminated by the film 3. This requirement is essential in either case shown in FIG. 1 or 2.

In other words, in the case shown in FIG. 1 wherein a bonding agent is applied on the external surface of a roll 31, the roll 31 must be unwound as shown in FIG. 1. This causes the surface A applied a bonding agent to contact the surface of the rectangle 4 rather than the surface of the heating and pressing roll 21 and/or 22.

On the other hand, in the case shown in FIG. 2 wherein a bonding agent is applied on the internal surface of a roll 31, the roll 31 must be unwound as shown in FIG. 2. This causes the surface A applied a bonding agent to contact the surface of the rectangle 4 rather than the surface of the heating and pressing roll 21 and/or 22.

Referring to FIG. 3, an exemplary rolled film available in the prior art will be described below.

The rolled film 31 is employable for supplying a film 3 that is applied a bonding agent on one surface of the film 3, toward a laminating machine (not shown in FIG. 3). The bonding agent becomes adhesive exclusively under a high temperature. The film 3 applied a bonding agent on one surface of the film 3 is wound around an axis 311. Coupling means 313a or 313b is available at each end 312a and 312b of the axis 311 to couple each end 312a and 312b of the axis 311 and the laminating machine (not shown in FIG. 3). In FIG. 3, the coupling means 313a and 313b are embodied in combination of a recess or groove 313a or 313b arranged on the axis end 312a or 312b and a projection or a bearing 5a or 5b arranged on the laminating machine (not shown in FIG. 3).

Referring to FIGS. 4 and 5, if the direction of a rolled object 6 of which the position or direction is shown in FIG. 4 is reversed to the direction shown in FIG. 5, the top surface F of the film shown in FIG. 4 or the surface A applied a bonding agent is inverted to the rear surface RE shown in FIG. 5.

The phenomenon wherein alteration of the direction of the axis of a rolled object 6 shown in FIG. 4 causes reversion of the surface of the film that composes the rolled object 6 from the top surface F toward the rear surface RE accounts for the following corresponding phenomenon. Namely, referring to FIGS. 1 and 2 again, if the rolled film 31 is arranged in a wrong direction (in the direction opposite to the originally designed direction), the surface A that is applied a bonding agent does not face the object 4 that is scheduled to be laminated by the film but faces the heating and pressing roll 21 or 22, resultantly disabling the surface A that is applied a bonding agent from contacting the object 4 that is scheduled to be laminated by the film 3. As a result, lamination of the film 3 on the surface of the object 4 can not be realized. In addition, since the surface A that is applied a bonding agent sticks to the heating and pressing roll 21 and/or 22, a great deal of work is required to remove the film stuck to the heating and pressing rolls 21 and/or 22. Moreover, great damage is potentially caused for the laminating machine.

Therefore, whenever the rolled film 31 is arranged to a laminating machine, a great deal of attention is required to be paid not to arrange the rolled film 31 in a wrong direction. Otherwise, possibility of occurring the foregoing drawbacks is very large.

For the purpose to remove the foregoing drawbacks, it is known that a model or a variation of such a rolled film having an axis composed of the both ends alone (In other words, the center portion of the axis is removed.) is available. Unfortunately, however, the inventor of this invention does not know if a piece of patent information regarding the improved model or variation is available. Moreover, he does not understand the inventive concept of the improved model or variation.

### SUMMARY OF THE INVENTION

Accordingly, the object of this invention is to provide a rolled film employable for supplying a film that is applied a bonding agent on one surface thereof, toward a laminating machine that has a function to laminate a film on one or both surfaces of a tangible object e.g. a book or the like, the rolled film being free from the drawbacks described above.

More specifically, the object of this invention is to provide a rolled film that has no possibility to be arranged in a wrong direction that causes possibility wherein the surface of the film composing a rolled film that is applied a bonding agent, does not contact the object that is scheduled to be laminated by the film but contacts the heating and pressing roll, resultantly removing possibility wherein the surface applied a bonding agent is accidentally caused to contact the heating and pressing roll and the bonding agent is accidentally caused to stick to the object to be laminated, further resultantly removing the necessity to remove the film stuck to the heating and pressing roll and possibility to cause great damage to a laminating machine.

Referring to FIGS. 6 and 7, the conceptual structure of the new rolled film (31) in accordance with this invention will be described below.

A rolled film (31) employable for supplying a film that is applied a bonding agent on one surface thereof, toward a laminating machine that has a function to laminate a film on one or both surfaces of a tangible object that is called an object to be laminated in this specification, comprises

an axis (311) around which a film (3) applied a bonding agent on one surface thereof, is wound,

the axis (311) having a first end (312a) of the axis (311) further having a first coupling means (313a) having a function to couple itself with a first accepting means (5a) or a first bearing means (5a) that is supported by a laminating machine (not shown in the drawings), and
the axis (311) having a second end (312b) of the axis (311) further having a second coupling means (313b) having a function to couple itself with a second accepting means (5b) or a second bearing means (5b) that is supported by a laminating machine (not shown in the drawings), wherein:

the first coupling means (313a) has no function to couple itself with the second accepting means (5b) and/or the second coupling means (313b) has no function to couple itself with the first accepting means (5a).

As a result, an action to arrange the rolled film (31) of this invention having the foregoing conceptual structure with a laminating machine in a wrong direction or in a direction wherein the first coupling means (313a) does not face the first accepting means (5a) or the first bearing means (5a) and/or the second coupling means (313b) does not face the second accepting means (5b) or the second bearing means (5b), turns out unsuccessful. In other words, it is impossible to couple the rolled film (31) of this invention with the laminating machine, unless the direction is correct or the direction allows the first coupling means (313a) to face the first accepting means (5a) or the first bearing means (5a) and the second coupling means (313b) to face the second accepting means (5b) or the second bearing means (5b).

Therefore, there is no possibility wherein the surface of the film composing the rolled film that is applied a bonding agent, does not contact the object that is scheduled to be laminated by the film but contacts the heating and pressing roll, resultantly removing possibility wherein the surface applied a bonding agent is accidentally caused to contact the heating and pressing roll and the bonding agent is accidentally caused to stick to the object to be laminated, further resultantly removing the necessity to remove the film stuck to the heating and pressing roll and possibility to cause great damage to a laminating machine.

In this manner, this invention successfully realizes the advantage to remove the foregoing drawbacks.

Specifically, the foregoing first coupling means (313a) and the first accepting means (5a) can be embodied in a combination of a groove and a projection, and the foregoing second coupling means (313b) and the second accepting means (5b) can be embodied in a combination of a groove and a projection, as well.

Important is that, however, the foregoing first coupling means (313a) does not match the foregoing second accepting means (5b), and/or the foregoing second coupling means (313a) does not match the foregoing first accepting means (5b).

More specifically, the width and/or the depth and/or the shape of the foregoing first coupling means (313a) is designed to be different respectively from the width and/or the height and/or the shape of the foregoing second accepting means (5b), and vice versa.

Moreover, approved for this invention is a combination of a stepped or square groove and a round projection, and vice versa To make the description simpler, any combination of a coupling means (313a) or (313b) and any accepting means (5a) or (5b) that does not match with each other successfully works for the purpose of this invention.

### BRIEF DESCRIPTION OF THE DRAWINGS

FIG. 1 is a conceptual side-view of a laminating machine employing two rolled films respectively having a rolled film being applied a bonding agent on the external surface of a rolled film, available in the prior art,

FIG. 2 is a conceptual side-view of a laminating machine employing two rolled films respectively having a rolled film being applied a bonding agent on the internal surface of a rolled film, available in the prior art,

FIG. 3 is a front view of a rolled film available in the prior art,

FIG. 4 is a conceptual perspective view of a rolled object drawn for the purpose to explain the phenomenon wherein an alteration of the direction of the rolled object causes a reversion of the surface of a film composing the rolled object,

FIG. 5 is a conceptual perspective view of a rolled object drawn for the purpose to explain the phenomenon wherein an alteration of the direction of a rolled object causes a reversion of the surface of a film composing the rolled object,

FIG. 6 is a front view of a rolled film in accordance with the first embodiment of this invention, and

FIG. 7 is a front view of a rolled film in accordance with the second embodiment of this invention.

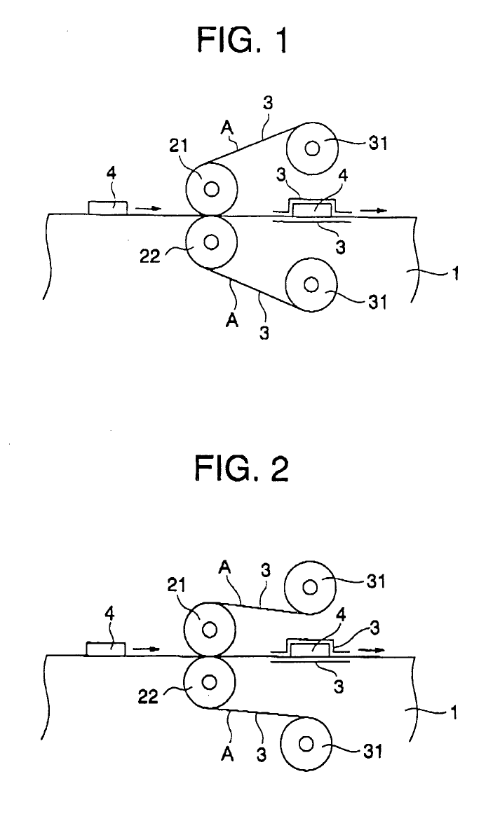

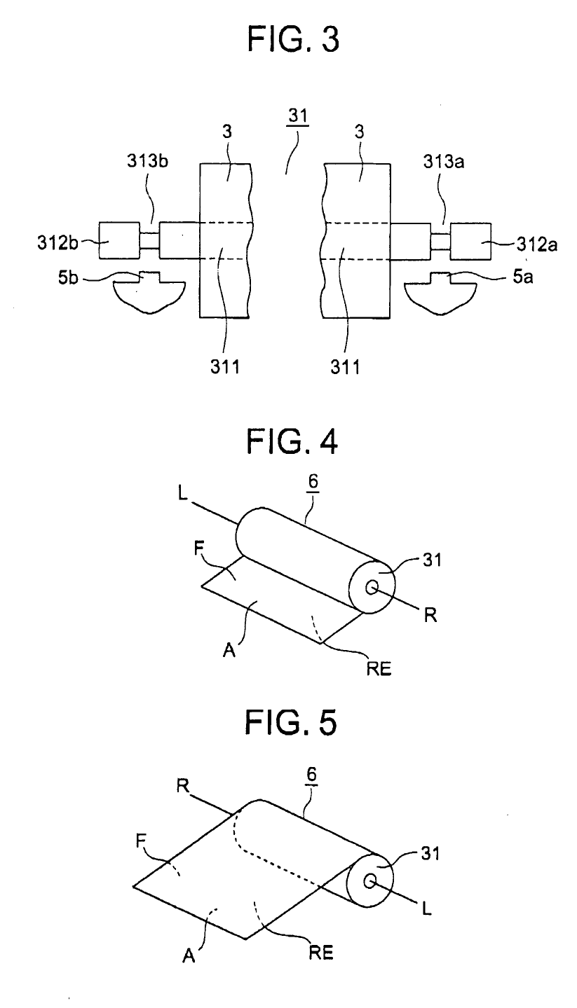

### BEST MODES IMPLEMENTING THIS INVENTION

Referring to drawings, rolled films in accordance with two embodiments of this invention will be described below. More specifically, in the first embodiment, the coupling means is realized by a square groove or a stepped groove 313a or 313b having the width different from each other, and in the second embodiment, the coupling means is realized by a round groove 313a or 313b having the width different from each other.

### First Embodiment

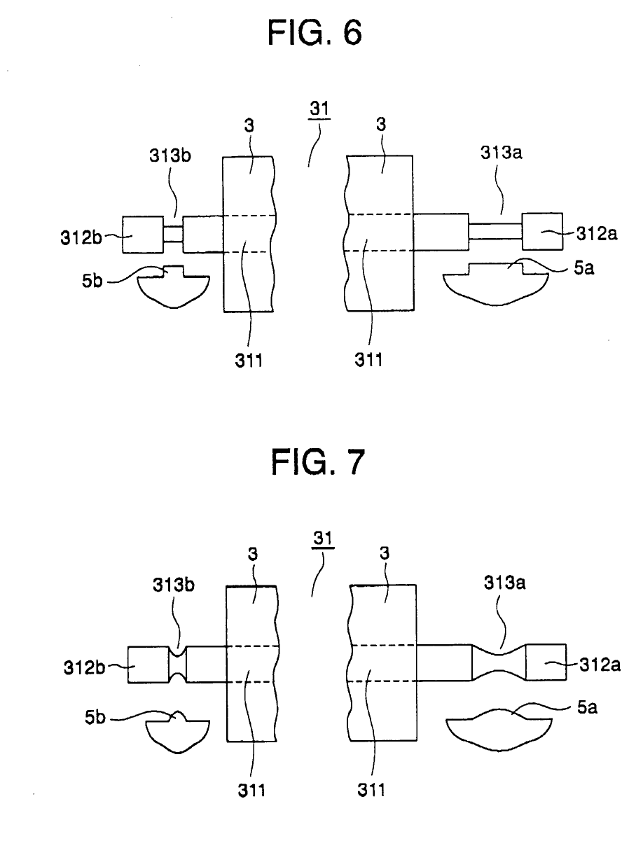

Referring to FIG. 6, a film (3) applied a bonding agent that becomes adhesive exclusively under a high temperature, on one surface of the film (3) is wound around an axis (311) to make a rolled film (31) in accordance with the first embodiment of this invention.

Representing the first and second coupling means (313a) and (313b), stepped grooves (313a) and (313b) are arranged respectively at the first end (312a) and the second end (312b) of the axis (311). Representing the first and second accepting means (5a) and (5b), stepped or square projections (5a) and (5b) are prepared on a laminating machine (not shown in the drawings.).

For the purpose to distinguish the first coupling means (313a) and the second accepting means (5b), the width and/or the depth and/or the shape of the foregoing first coupling means (313a) is designed to be different respectively from the width and/or the height and/or the shape of the foregoing second accepting means (5b), and vice versa.

Since the width and/or the depth and/or the shape of the first coupling means (313a) is different respectively from the width and/or the height and/or the shape of the foregoing second accepting means (5b), an action to couple the first coupling means (313a) with the second accepting means (5b) turns out unsuccessful.

Although FIG. 6 shows the difference between the first and second coupling means is limited to the difference respectively in the width, same results are realized by difference in width and/or the depth (height) and/or the shape, as well.

Since the rolled film (31) of this embodiment can not be fit a laminating machine, the foregoing drawbacks are successfully removed.

### Second Embodiment

Referring to FIG. 7, a film (3) applied a bonding agent that becomes adhesive exclusively under a high temperature, on one surface of the film (3) is wound around an axis (311) to make a rolled film (31) in accordance with the second embodiment of this invention. Representing the first and second coupling means (313a) and (313b), round grooves (313a) and (313b) are arranged respectively at the first end (312a) and the second end (312b) of the axis (311). The difference between stepped grooves and round grooves is the only difference between the first and second embodiments.

For the purpose to distinguish the first coupling means (313a) and the second accepting means (5b), the width and/or the depth and/or the shape of the foregoing first coupling means (313a) is designed to be different respectively from the width and/or the height and/or the shape of the foregoing second accepting means (5b), and vice versa.

Based on the same principle for the first embodiment, a rolled film (31) in accordance with the second embodiment of this invention can not be fit a laminating machine.

Thus, it is easy to identify whether or not the rolled film (3) matches the laminating machine. Further, it is quite easy to prevent occurrence of a grave accident.

In this manner, the foregoing drawbacks are successfully removed.

The foregoing description has clarified that this invention has successfully provided a rolled film that is free from the drawbacks described above.

1. A rolled film (31) employable for supplying a film (3) applied a bonding agent on one surface thereof, toward a laminating machine comprising:
an axis (311) around which said film (3) is wound, said axis (311) having a first end (312a) of said axis (311) further having a first coupling means (313a) having a function to couple with a first accepting means (5a) that is supported by said laminating machine, and
said axis (311) having a second end (312b) of said axis (311) further having a second coupling means (313b) having a function to couple with a second accepting means (5b) that is supported by said laminating machine, wherein:
said first coupling means (313a) has a structure that can not couple with said second accepting means (5a) or said second coupling means (313b) has a structure that can not couple with said first accepting means (5a).

2. A rolled film (31) in accordance with claim 1, wherein:
said first coupling means (313a) and said second coupling means (313b) are grooves and said first accepting means (5a) and said second accepting means (5b) are projections.

3. A rolled film (31) in accordance with claim 2, wherein:
said grooves are square grooves and said projections are square projections.

4. A rolled film (31) in accordance with claim 2, wherein:
said grooves are round grooves and said projections are round projections.

5. A rolled film (31) in accordance with claim 1, wherein:
the width, the depth and/or the shape of said grooves of said first coupling means (313a) is or are different from the width, the height and/or the shape of said projections of said second accepting means (5b).

6. A rolled film (31) in accordance with claim 2, wherein:
the width, the depth and/or the shape of said grooves of said first coupling means (313a) is or are different from the width, the height and/or the shape of said projections of said second accepting means (5b).

7. A rolled film (31) in accordance with claim 3, wherein:
the width, the depth and/or the shape of said grooves of said first coupling means (313a) is or are different from the width, the height and/or the shape of said projections of said second accepting means (5b).

8. A rolled film (31) in accordance with claim 4, wherein:
the width, the depth and/or the shape of said grooves of said first coupling means (313a) is or are different from the width, the height and/or the shape of said projections of said second accepting means (5b).
